(19) United States
(12) Patent Application Publication
(10) Pub. No.: US 2014/0118603 A1
(43) Pub. Date: May 1, 2014

(54) ZOOM LENS AND IMAGE PICKUP APPARATUS

(71) Applicant: CANON KABUSHIKI KAISHA, Tokyo (JP)

(72) Inventor: Shinichiro Saito, Utsunomiya-shi (JP)

(21) Appl. No.: 14/060,126

(22) Filed: Oct. 22, 2013

(30) Foreign Application Priority Data
Oct. 30, 2012 (JP) 2012-238822

(51) Int. Cl. G02B 15/14; H04N 5/225

(52) U.S. Cl. CPC G02B 15/14; H04N 5/2254
USPC 348/340; 359/690

(57) ABSTRACT

The zoom lens includes, in order from an object side to an image side, first, second and third lens units respectively having positive, negative and positive refractive powers, and a rear lens group. The second lens unit and a most-object side lens unit of the rear lens group are moved during zooming, and the first lens unit is not moved for zooming. The first lens unit includes one negative lens and three positive lenses. Conditions of 5.0<f1/|f2|<7.0 and −0.2<(R1+R2)/(R1−R2)<1.1 are satisfied where f1 represents a focal length of the first lens unit, f2 represents a focal length of the second lens unit, and R1 and R2 respectively represent curvature radii of an object side lens surface and an image side lens surface of the negative lens included in the first lens unit.

### BACKGROUND OF THE INVENTION

1. Field of the Invention

The present invention relates to a zoom lens to be used for image pickup apparatuses such as digital still cameras, silver-halide film cameras, video cameras, TV cameras and surveillance cameras.

2. Description of the Related Art

As image capturing optical systems to be used for the above-mentioned image pickup apparatuses, a compact zoom lens having a wide angle of view, a high zoom ratio and a high resolution is required.

Generally, miniaturization of a zoom lens while securing a certain zoom ratio is achieved by reducing number of lenses included in the zoom lens while increasing refractive powers of respective lens units constituting the zoom lens. However, in the zoom lens having such a configuration, a thickness of each lens is increased with increase of a refractive power of each lens surface, which makes a reduction effect of a zoom lens length insufficient and increases various aberrations difficult to be corrected.

In a positive lead zoom lens in which a most-object side lens unit (first lens unit) has a positive refractive power, it is important to appropriately set each of elements constituting the zoom lens in order to achieve a high optical performance while miniaturizing the entire zoom lens and securing a high zoom ratio. For example, is important to appropriately set number of lens units to be moved during zooming, refractive powers of the lens units, movement loci of the lens units during zooming, magnification variation burdens of the lens units and a position of an aperture stop.

In particular, it is important to appropriately set a lens configuration and a refractive power of the first lens unit and a refractive power of a second lens unit as a magnification varying lens. Inappropriate setting thereof increases size of the entire zoom lens with increase of the zoom ratio and increases variation of various aberrations (especially, field curvature) during zooming; the variation thereof makes it difficult to achieve a high optical performance in an entire zoom range and in an entire angle of view.

Japanese Patent Laid-open Nos. 2009-3242 and 2009-204942 each disclose a zoom lens constituted by, in order from an object side to an image side, a first lens unit having a positive refractive power, a second lens unit having a negative refractive power, a third lens unit having a positive refractive power and a fourth lens unit having a positive refractive power. The first to fourth lens units are moved during zooming, and the fourth lens unit is moved for focusing. In this zoom lens, constituting the first lens unit by one negative lens and three positive lenses miniaturizes the entire zoom lens.

On the other hand, Japanese Patent Laid-open No. 2004-117826 discloses a zoom lens constituted by, in order from an object side to an image side, a first lens unit having a positive refractive power, a second lens unit having a negative refractive power, a third lens unit having a positive refractive power, a fourth lens unit having a positive refractive power and a fifth lens unit having a positive refractive power.

### SUMMARY OF THE INVENTION

The present invention provides a zoom lens having a good optical performance in its entire zoom range while having a high zoom ratio, a wide angle of view and a small diameter of a front lens unit (first lens unit), and provides an image pickup apparatus using the zoom lens.

The present invention provides as one aspect thereof a zoom lens including, in order from an object side to an image side, a first lens unit having a positive refractive power, a second lens unit having a negative refractive power, a third lens unit having a positive refractive power, and a rear lens group including at least one lens unit. The second lens unit and a most-object side lens unit of the rear lens group are moved during zooming, and the first lens unit is not moved for zooming. The first lens unit includes, in order from the object side to the image side, one negative lens and three positive lenses. The following conditions are satisfied:

5.0<f1/|f2|<7.0

−0.2<(R1+R2)/(R1−R2)<1.1

where f1 represents a focal length of the first lens unit, f2 represents a focal length of the second lens unit, and R1 and R2 respectively represent curvature radii of an object side lens surface and an image side lens surface of the negative lens included in the first lens unit.

The present invention provides as another aspect thereof an image pickup apparatus including the above zoom lens, and an image sensor to photoelectrically converts an optical image formed by the zoom lens.

Further features of the present invention will become apparent from the following description of exemplary embodiments (with reference to the attached drawings).

### BRIEF DESCRIPTION OF THE DRAWINGS

FIGS. 1A, 1B, 1C and 1D are sectional views of a zoom lens that is Embodiment 1 at a wide-angle end, a first intermediate zoom position, a second intermediate zoom position and a telephoto end, respectively.

FIGS. 2A, 2B, 2C and 2D are aberrational charts of the zoom lens of Embodiment 1 at the wide-angle end, the first intermediate zoom position, the second intermediate zoom position, and the telephoto end, respectively.

FIGS. 3A and 3B are lateral aberration charts in a state where an image position is displaced by an angle of view of 0.3° at the wide-angle end and the telephoto end in Embodiment 1.

FIGS. 4A, 4B, 4C and 4D are sectional views of a zoom lens that is Embodiment 2 at a wide-angle end, a first intermediate zoom position, a second intermediate zoom position and a telephoto end, respectively.

FIGS. 5A, 5B, 5C and 5D are aberration charts of the zoom lens of Embodiment 2 at the wide-angle end, the first intermediate zoom position, the second intermediate zoom position, and the telephoto end, respectively.

FIGS. 6A, 6B, 6C and 6D are sectional views of a zoom lens that is Embodiment 3 at a wide-angle end, a first intermediate zoom position, a second intermediate zoom position and a telephoto end, respectively.

FIGS. 7A, 7B, 7C and 7D are aberration charts of the zoom lens of Embodiment 3 at the wide-angle end, de first intermediate zoom position, the second intermediate zoom position and the telephoto end, respectively.

FIGS. 8A and 8B are lateral aberration charts in a state where an image position is displaced by an angle of view of 0.3° at the wide-angle end and the telephoto end in Embodiment 3.

FIGS. 9A, 9B, 9C and 9D are sectional views of a zoom lens that is Embodiment 4 at a wide-angle end, a first intermediate zoom position, a second intermediate zoom position and a telephoto end, respectively.

FIGS. 10A, 10B, 10C and 10D are aberration charts of the zoom lens of Embodiment 4 at the wide-angle end, the first intermediate zoom position, the second intermediate zoom position and the telephoto end, respectively.

FIGS. 11A and 11B are lateral aberration charts in a state where an image position is displaced by an angle of view of 0.3° at the wide-angle end and the telephoto end in Embodiment 4.

FIGS. 12 and 13 are schematic views of image pickup apparatuses that are Embodiments 5 and 6 of the present invention.

### DESCRIPTION OF THE EMBODIMENTS

Exemplary embodiments of the present invention will hereinafter be described with reference to the accompanying drawings.

A zoom lens of each of embodiments described below includes, in order from an object side to an image side, a first lens unit having a positive refractive power (which is an inverse of a focal length), a second lens unit having a negative refractive power, a third lens unit having a positive refractive power and a rear unit including at least one lens unit. The first lens unit is not moved for zooming. During zooming, the second lens unit and a most-object side lens unit of the rear unit are moved as magnification varying lens units.

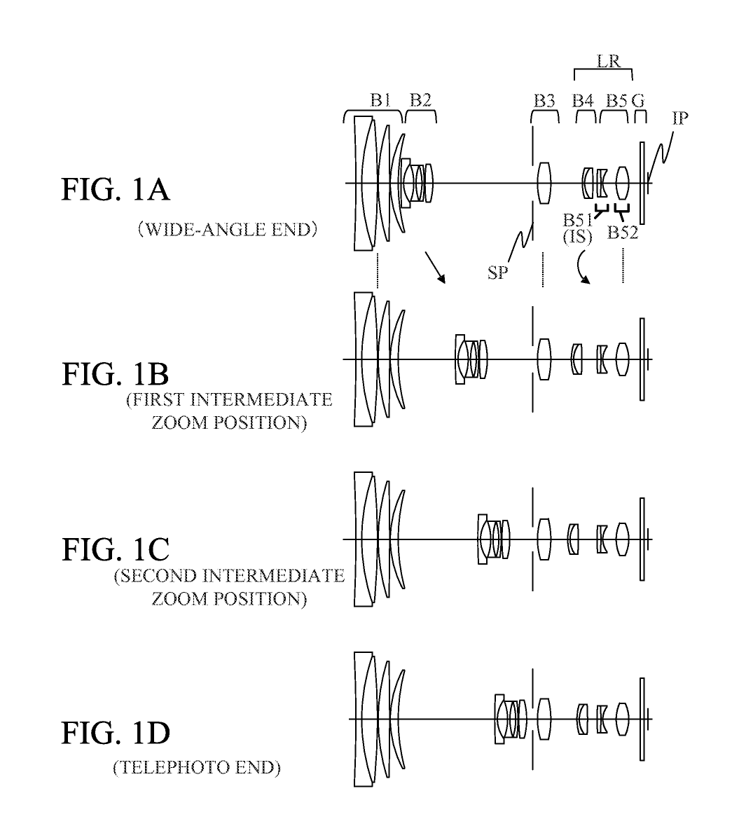

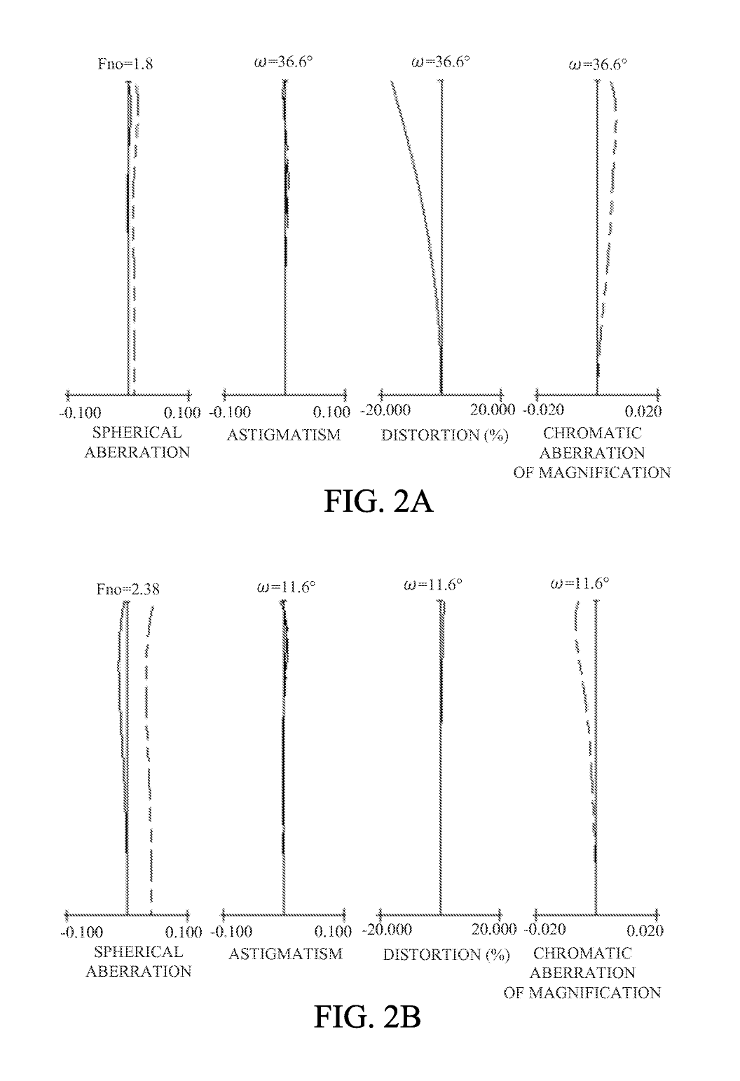

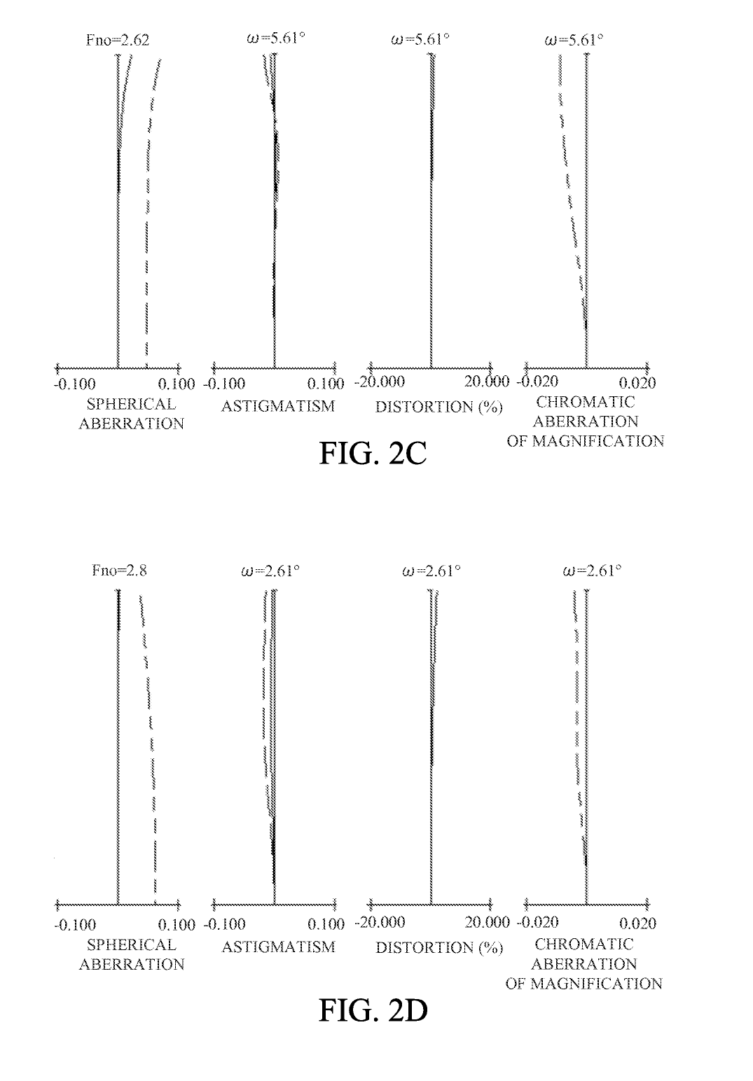

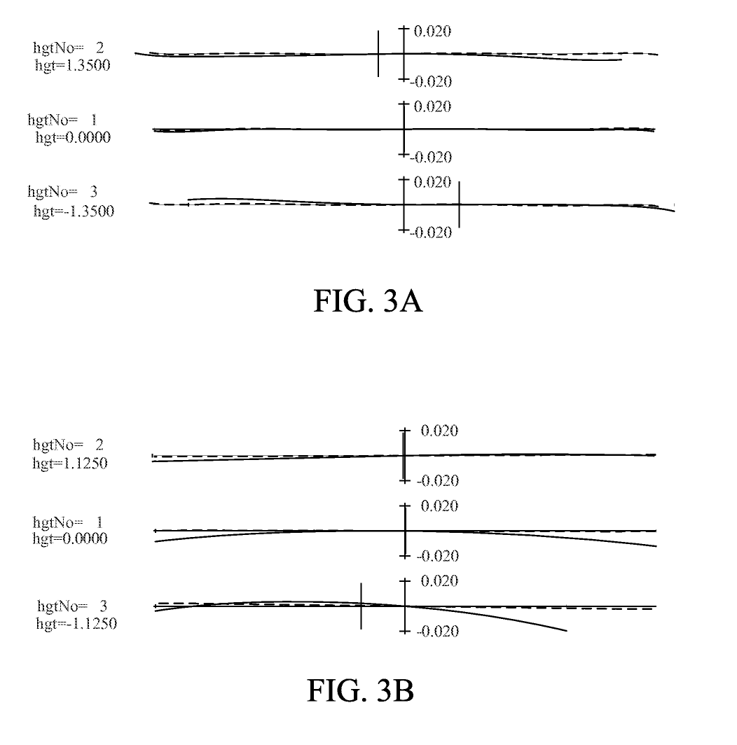

FIGS. 1A, 1B, 1C and 1D are sectional views of a zoom lens that is a first embodiment (Embodiment 1) of the present invention at a wide-angle end (short side focal length end), a first intermediate zoom position, a second intermediate zoom position and a telephoto end (long side focal length end), respectively. FIGS. 2A, 2B, 2C and 2D are aberration charts of the zoom lens of Embodiment 1 at the wide-angle end, the first intermediate zoom position, the second intermediate zoom position and the telephoto end, respectively. FIGS. 3A and 3B are lateral aberration charts of the zoom lens of Embodiment 1 in a state where an image position is displaced by an angle of view of 0.3° at the wide-angle end and the telephoto end. The zoom lens of Embodiment 1 has a zoom ratio of 13.57 and an aperture ratio of approximately 1.80-2.80.

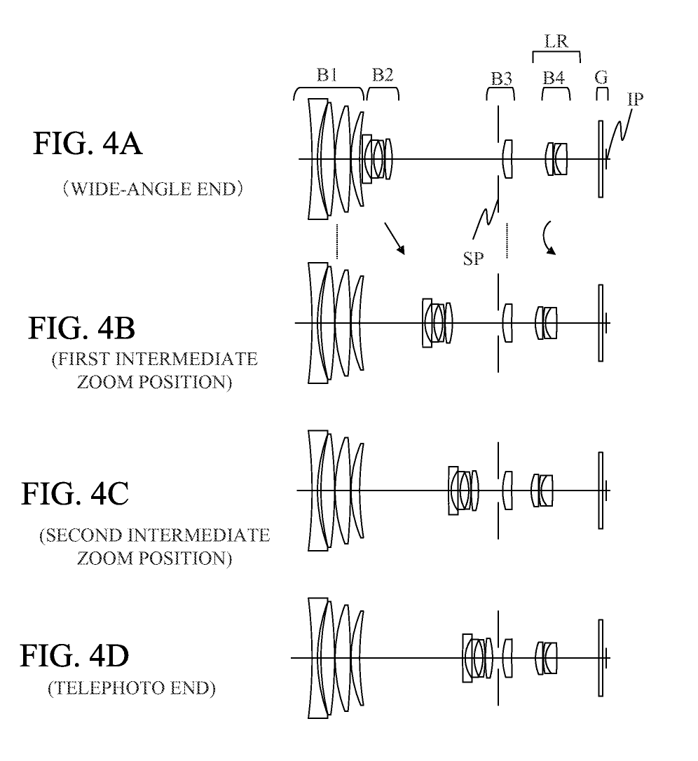

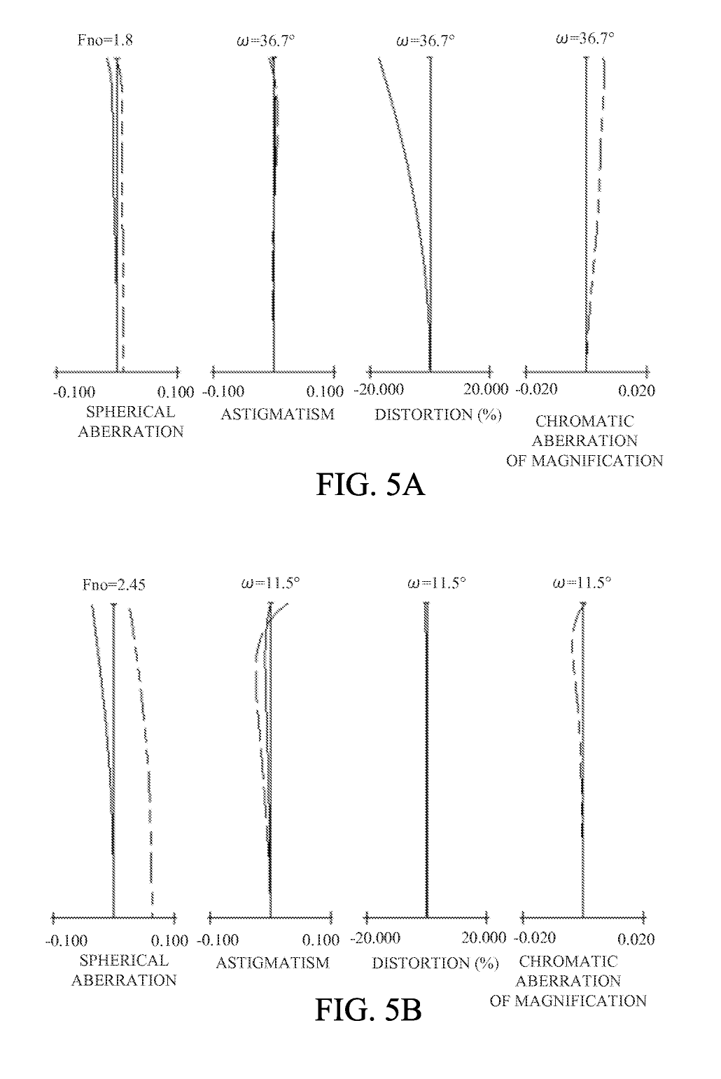

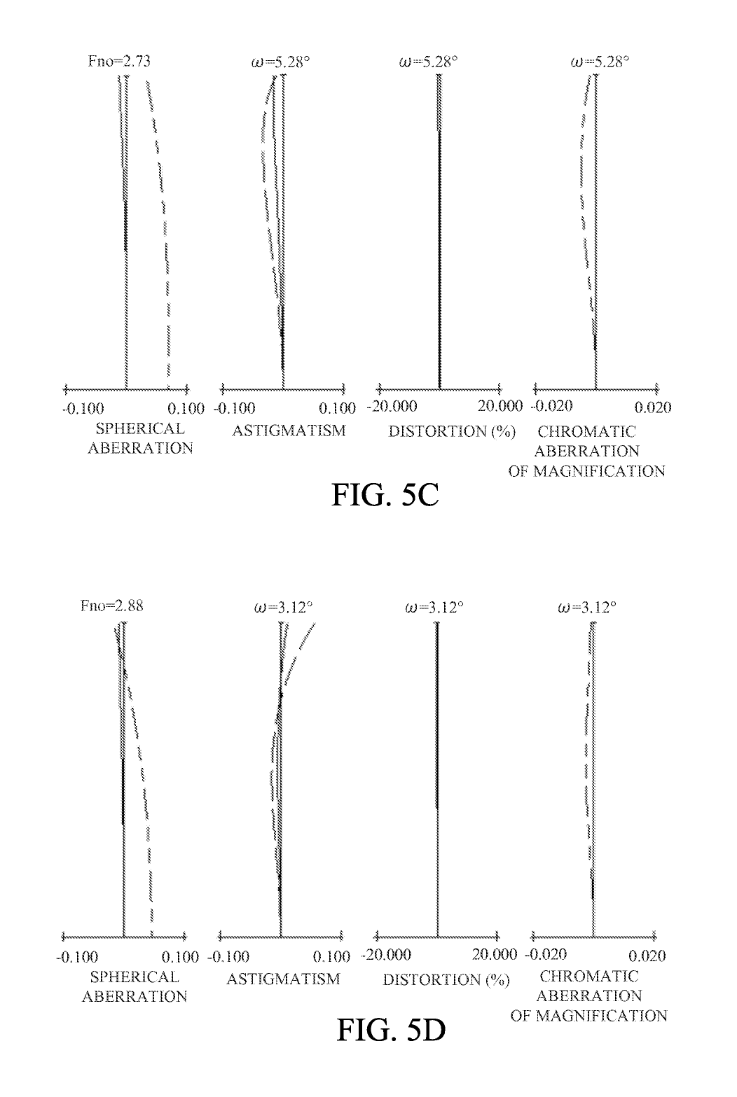

FIGS. 4A, 4B, 4C and 4D are sectional views of a zoom lens that is a second embodiment. (Embodiment. 2) of the present invention at a wide-angle end, a first intermediate zoom position, a second intermediate zoom position and a telephoto end, respectively. FIGS. 5A, 5B, 5C and 5D are aberration charts of the zoom lens of Embodiment 2 at the wide-angle end, the first intermediate zoom position, the second intermediate zoom position and the telephoto end, respectively. The zoom lens of Embodiment 2 has a zoom ratio of 11.85 and an aperture ratio of approximately 1.80-2.88.

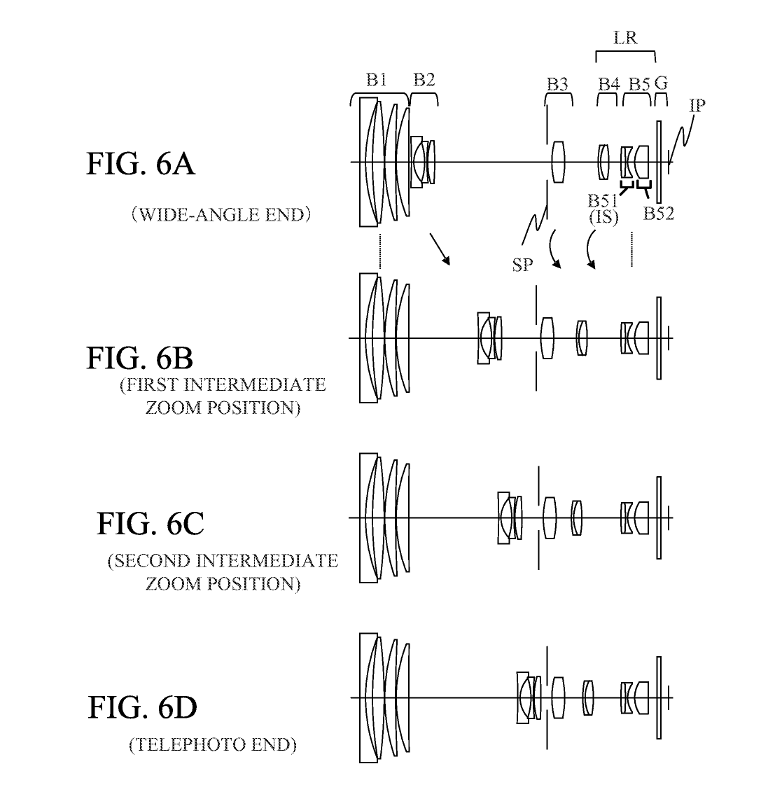

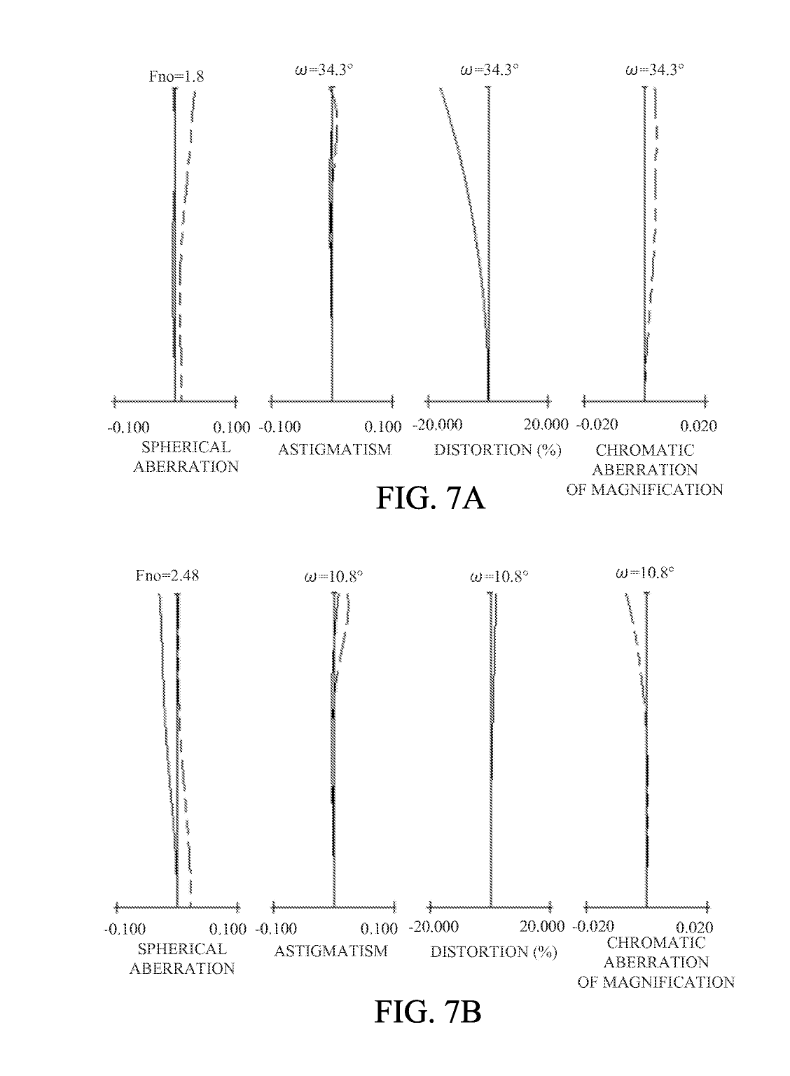

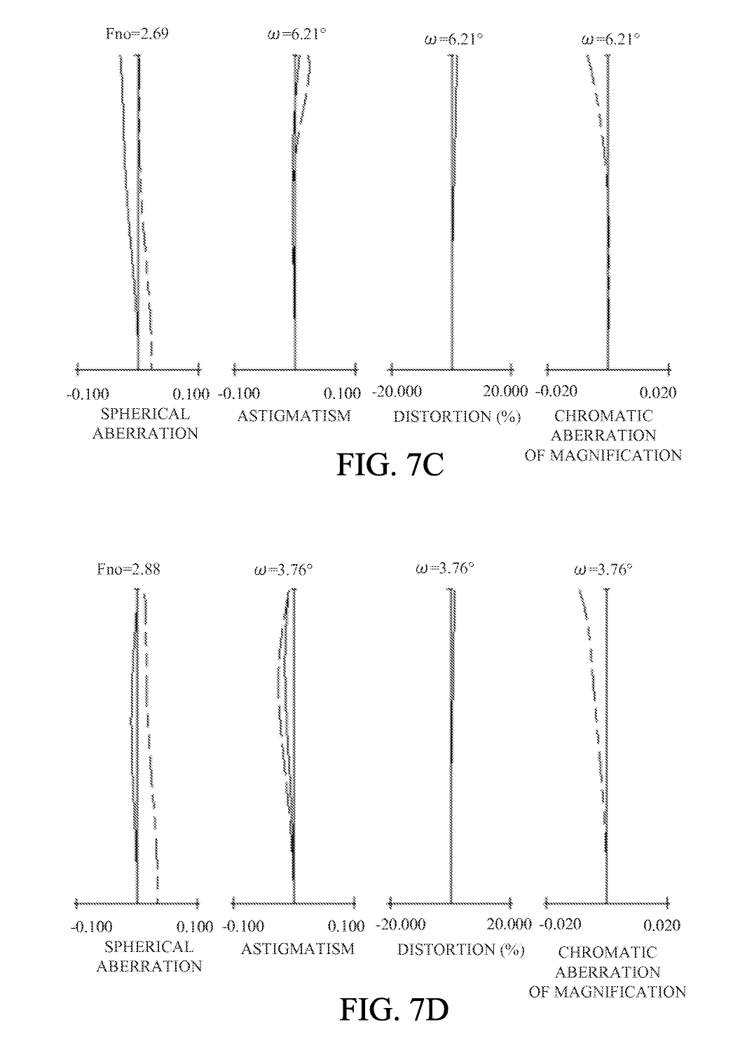

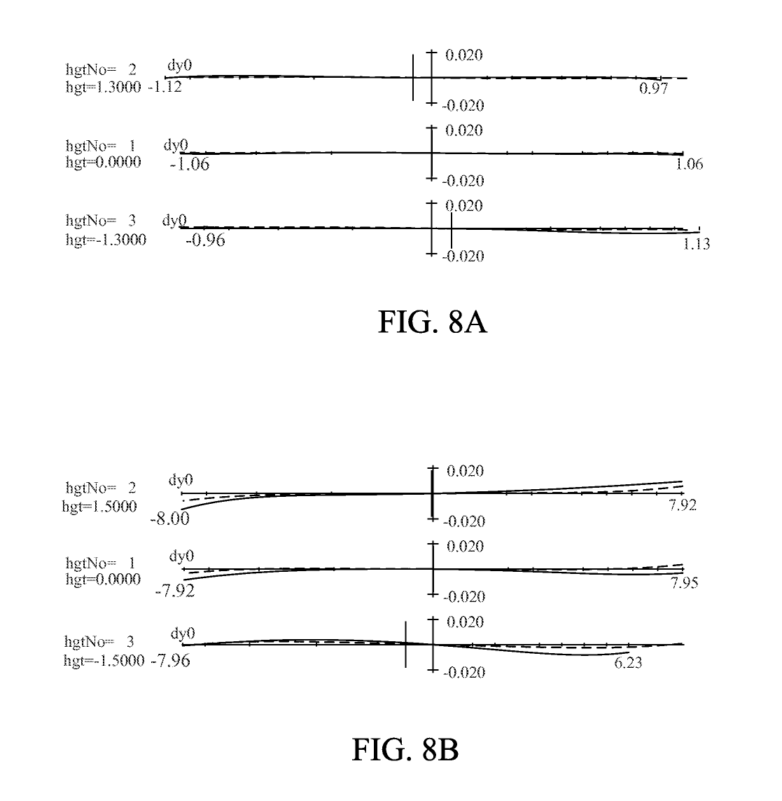

FIGS. 6A, 6B, 6C and 6D are sectional views of a zoom lens that is a third embodiment (Embodiment 3) of the present invention at a wide-angle end, a first intermediate zoom position, a second intermediate zoom position and a telephoto end, respectively. FIGS. 7A, 7B, 7C and 7D are aberration charts of the zoom lens of Embodiment 3 at the wide-angle end, the first intermediate zoom position, the second intermediate zoom position and the telephoto end, respectively. FIGS. 8A and 8B are lateral aberration charts of the zoom lens of Embodiment 3 in a state where an image position is displaced by an angle of view of 0.3° at the wide-angle end and the telephoto end. The zoom lens of Embodiment 3 has a zoom ratio of 11.99 and an aperture ratio of approximately 1.80-2.88.

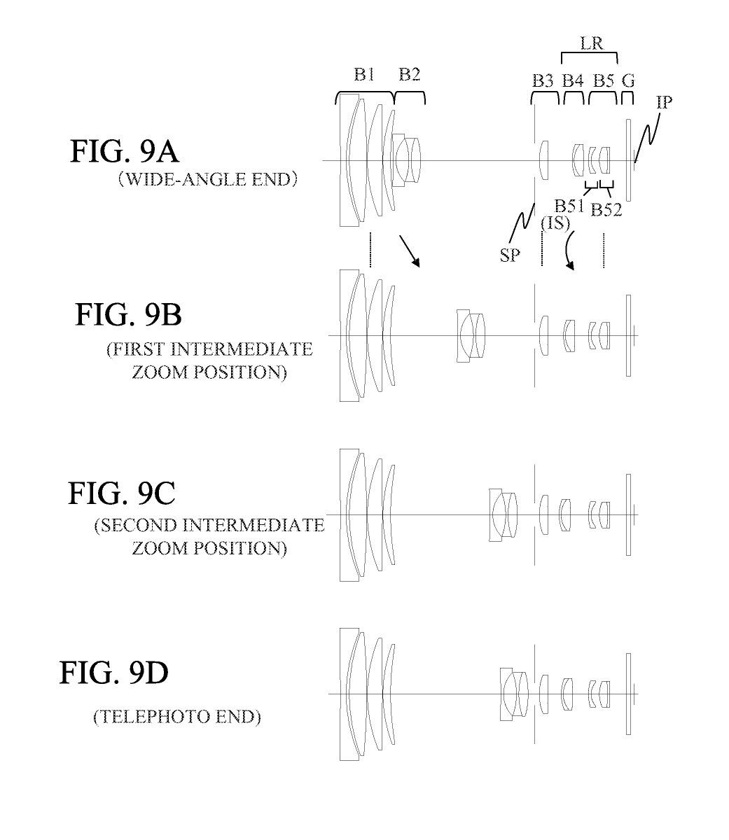

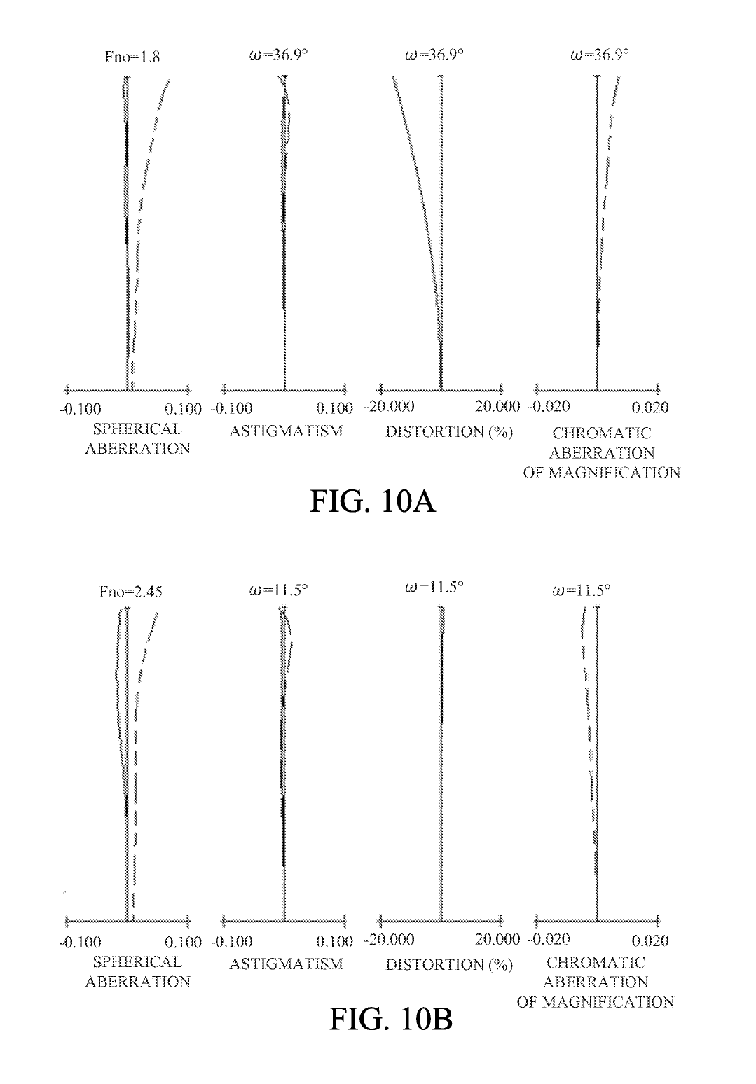

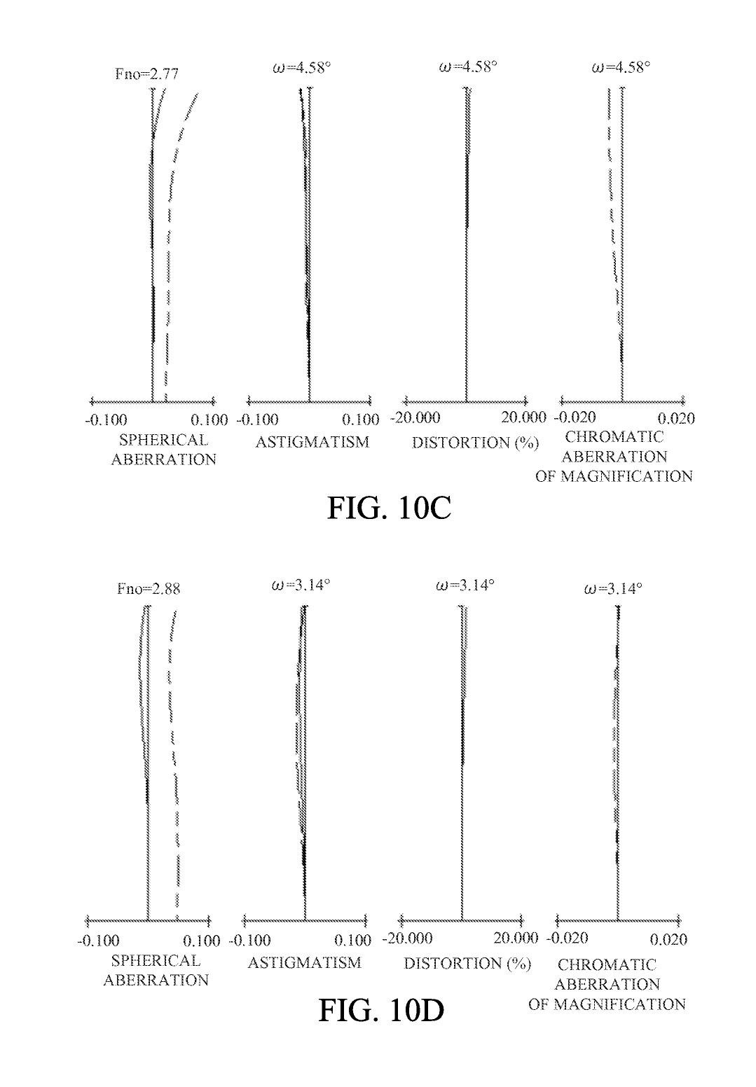

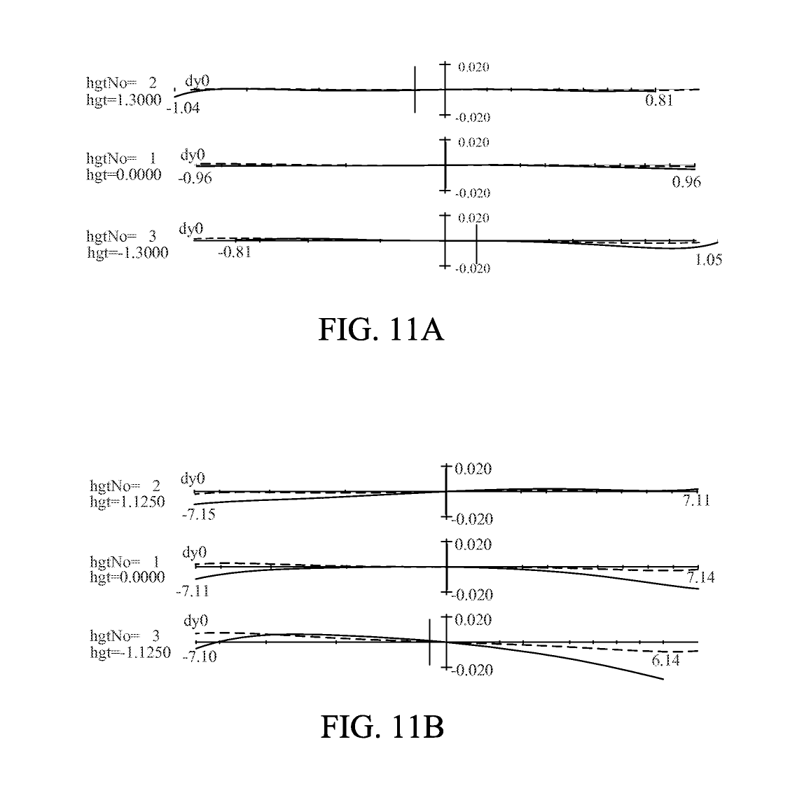

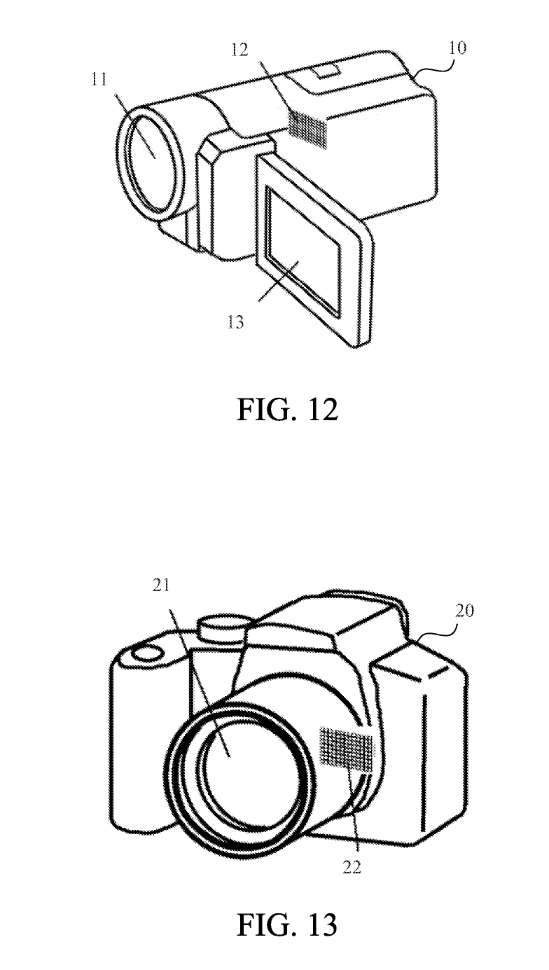

FIGS. 9A, 9B, 9C and 9D are sectional views of a zoom lens that is a fourth embodiment (Embodiment 4) of the present invention at a wide-angle end, a first intermediate zoom position, a second intermediate zoom position and a telephoto end, respectively. FIGS. 10A, 10B, 10C and 10D are aberration charts of the zoom lens of Embodiment 4 at the wide-angle end, the first intermediate zoom position, the second intermediate zoom position and the telephoto end, respectively. FIGS. 11A and 11B are lateral aberration charts of the zoom lens of Embodiment 4 in a state where an image position is displaced by an anode of view of 0.3° at the wide-angle end and the telephoto end. The zoom lens of Embodiment 4 has a zoom ratio of 11.83 and an aperture ratio of approximately 1.80-2.88.

The zoom lens of each embodiment is used as an image capturing optical (lens) system for image pickup apparatuses such as video cameras, digital still cameras, silver-halide film cameras, TV cameras and surveillance cameras. The zoom lens of each embodiment can be used also as a projection optical system for an image projection apparatus (projector). In the sectional views of the zoom lens of each embodiment, a left side corresponds to the object side (front side), and a right side corresponds to the image side (rear side).

Moreover, in the sectional views, Bi represents an i-th lens unit where i represents a number in order from the object side, and LR denotes the rear unit including at least one lens unit. Furthermore, SP denotes an aperture stop that determines (limits) a light flux corresponding to a fully-opened F-number (Fno). G denotes an optical block such as an optical filter, a faceplate, a low-pass filter or an infrared cutting filter. IP denotes an image plane. The image plane IP corresponds to an image pickup plane of a solid-state image sensor (photoelectric conversion element) such as a charge-coupled device (CCD) sensor or a complementary metal-oxide semiconductor (CMOS) sensor when the zoom lens is used for the image capturing optical system for a video camera or a digital still camera. When the zoom lens is used as the image capturing optical system of a silver-halide film camera, the image plane IP corresponds to a film surface. Arrows show movement loci of the respective lens units during zooming (variation of magnification) from the wide-angle end to the telephoto end.

In the aberration charts, Fno represents an F number, and o represents a half angle of view (°) which is a value calculated by ray tracing. In a spherical aberration chart of the aberration charts, a solid line shows spherical aberration for a d-line (wavelength=587.6 nm), and a dashed-two dotted line shows spherical aberration for a g-line (wavelength=435.8 nm). In an astigmatism chart, a solid line and a dotted line respectively show astigmatism in a sagittal image plane and astigmatism in a meridional image plane for the d-line. In a distortion chart, distortion for the d-line is shown. In a chart of chromatic aberration of magnification, a dashed-two dotted line shows represents chromatic aberration of magnification for the g-line. In lateral aberration charts, hgt represents an image height, hgtNo=1 represents an image height corresponding to a position of an optical axis of the zoom lens, and hgtNo=2 represents a plus side image height, and hgtNo=3 represents a minus side image height.

In the following each embodiment, the wide-angle end and the telephoto end correspond to zoom positions when the magnification varying lens units are located at ends of a mechanically movable range on the optical axis. The zoom lens of each embodiment includes, in order from the object side to the image side, a first lens unit B1 having a positive refractive power, a second lens unit B2 having a negative refractive power, a third lens unit B3 having a positive refractive power and a rear unit LR including at least one lens unit.

The first lens unit B1 is not moved during (for) zooming. During zooming from the wide-angle end to the telephoto end, at least the second lens unit B2 is monotonously moved to the image side and a fourth lens unit B4 that is a most-object side lens unit of the rear unit LR is moved so as to draw a movement locus convex toward the object side. In this zooming, each movable lens is moved so that a distance between the first lens unit B1 and the second lens unit B2 increases and a distance between the second lens unit B2 and the third lens unit B3 decreases at the telephoto end as compared with the wide-angle end. In each embodiment, the aperture stop SP is disposed between the second lens unit B2 and the third lens unit B3.

When focusing on from an infinite object to a close distance object is performed, the fourth lens unit B4 is moved to the object side. Such a rear focus type zoom lens has a smaller effective diameter of the first lens unit as compared with a zoom lens performing focusing by moving the first lens unit, which enables miniaturization of the entire zoom lens. Moreover, the rear focus zoom lens makes it easier to perform close-up image capturing. Furthermore, the rear focus zoom lens has a feature that high-speed focusing can be performed since a compact and light-weight lens unit is moved for focusing and thereby only a small driving power is necessary to drive the lens unit.

In the zoom lens of Embodiment 1, the rear unit LR is constituted by a fourth lens unit B4 having a positive refractive power and a fifth lens unit B5 having a positive refractive power. During zooming from the wide-angle end to the telephoto end, the second lens unit B2 is monotonously moved to the image side, and the fourth lens unit B4 is moved so as to draw a movement locus convex toward the object side. During zooming, the first lens unit B1, the third lens unit B3 and the fifth lens unit B5 are not moved.

In the zoom lens of Embodiment 2, the rear unit LR is constituted by a fourth lens unit B4 having a positive refractive power. During zooming from the wide-angle end to the telephoto end, the second lens unit B2 is monotonously moved to the image side, and the fourth lens unit B4 is moved so as to draw a movement locus convex toward the object side. During zooming, the first lens unit B1 and the third lens unit B3 are not moved.

In the zoom lens of Embodiment 3, the rear unit LP is constituted by a fourth lens unit B4 having a positive refractive power and a fifth lens unit B5 having a positive refractive power. During zooming from the wide-angle end to the telephoto end, the second lens unit B2 is monotonously moved to the image side, and the third lens unit B3 and the fourth lens unit B4 are each moved so as to draw a movement locus convex toward the object side. During zooming, the first lens unit B1 and the fifth lens unit B5 are not moved. The aperture stop SP is moved integrally with the third lens unit B3 (that is, so as to draw a same movement locus as that of the third lens unit B3).

In the zoom lens of Embodiment 4, the rear unit LR is constituted by a fourth lens unit B4 having a positive refractive power and a fifth lens unit B5 having a positive refractive power. During zooming from the wide-angle end to the telephoto end, the second lens unit B2 is monotonously moved to the image side, and the fourth lens unit B4 is moved so as to draw a movement, locus convex toward the object side. During zooming, the first lens unit B1, the third lens unit B3 and the fifth lens unit B5 are not moved.

In Embodiments 1, 3 and 4, the fifth lens unit B5 is constituted by, in order from the object side to the image side, a first lens component B51 having a negative refractive power and a second lens component B52 having a positive refractive power. The first lens component B51 as a correcting lens component is moved in a direction (hereinafter referred to as “a shift direction”) having a directional component orthogonal to the optical axis and thereby an imaging position is moved in a direction orthogonal to the optical axis, which corrects image blur due to shaking of the zoom lens (that is, performs image stabilization). Such image stabilization may be performed by moving any one of other lens units and lens components.

In each embodiment, the first lens unit B1 is constituted by (or consists of), in order from the object side to the image side, one negative lens and three positive lenses. When f1 and f2 respectively represent focal lengths of the first and second lens units B1 and B2, and R1 and R2 respectively represent curvature radii of an object side lens surface and an image side lens surface of the negative lens included in the first lens unit B1, the following conditions are satisfied:

5.0<f1/|f2|<7.0 (1)

0.2<(R1+R2)/(R1−R2)<1.1. (2)

The zoom lens of each embodiment employs, in order to correct various aberrations well while securing a high zoom ratio, a configuration including lens units having positive, negative, positive and positive refractive powers in order from the object side to the image side. Moreover, since the first lens unit B1 is not moved with respect to the image plane during zooming, a high position accuracy of the first lens unit B1 is maintained, a length of the entire zoom lens is not changed, and number of movable lens units is reduced to simplify mechanical components.

The simplification of the mechanical components can reduce occurrence of dust and the like in the zoom lens, which enables providing a zoom lens capable of maintaining a high optical performance and an image pickup apparatus using the same. Furthermore, the simplification of the mechanical components secures strength for attaching an accessory such as a converter lens to the zoom lens. Moving the second lens unit B2 and the fourth lens unit B4 during zooming reduces number of the movable lenses to achieve miniaturization of the entire zoom lens and simplification of the configuration thereof.

The first lens unit B1 is disposed at a most-object side position of the zoom lens. An off-axis light flux passes through the first lens unit B1 at a position apart from the optical axis. Since a configuration of the first lens unit B1 significantly influences the length of the entire zoom lens and a diameter thereof, it is important to appropriately set the lens configuration in order to provide a high optical performance while miniaturizing the entire zoom lens.

Thus, in each embodiment, the first lens unit B1 is constituted by, in order from the object side to the image side, one negative lens and three positive lenses, and curvature radii of lens surfaces of the respective positive lenses are set within an appropriate range, in order to suppress increase of an effective diameter of the first lens unit B1 as a front lens unit. Such a configuration of the first lens unit B1 facilitates correction of field curvature and chromatic aberration of magnification on a wide-angle side and correction of spherical aberration and coma aberration at a telephoto side while suppressing increase of burdens of the second lens unit B2 and the subsequent lens units for widening the angle of view.

Next, description will be made of technical meanings of conditions (1) and (2).

Condition (1) limits a ratio f1/|f2| of the focal lengths of the first lens unit B1 and the second lens unit B2. A too short focal length of the second lens unit B2 which makes the ratio higher than the upper limit of condition (1) is advantageous in increasing the angle of view and the zoom ratio, but undesirably increases a Petzval sum in a negative direction, which increases field curvature. On the other hand, a too short focal length of the first lens unit B1 which makes the ratio lower than the lower limit of condition (1) causes large amounts of axial chromatic aberration and spherical aberration from the first lens unit B1, which makes is difficult to correct these aberrations by other lens units.

Condition (2) limits a shape factor (lens shape) (R1+R2)/(R1−R2) of the negative lens included in the first lens unit B1. A higher shape factor than the upper limit of condition (2) makes it difficult to move an image side principal point of the first lens unit B1 to the image side, which increases the effective diameter of the first lens unit (front lens unit) B1. On the other hand, a lower shape factor than the lower limit of condition (2) makes a curvature of a concave shape of the object side lens surface of the first lens unit B1 too large, which causes large amounts of high-order aberrations and thereby makes it difficult to correct various aberrations when miniaturizing the entire zoom lens.

A configuration in which the ratio and the shape factor are respectively within the ranges of conditions (1) and (2) reduces various aberrations and increases the curvature radii of the respective lens surfaces, which eliminates necessity of adding new lenses to the first lens unit B1 and the second lens unit B2. As a result, number of lenses constituting the first and second lens units B1 and B2 can be reduced, which easily achieves miniaturization of the entire zoom lens and a high optical performance.

In each embodiment, it is desirable that at least one of the following conditions be satisfied. In the following conditions, f1n represents a focal length of the negative lens included in the first lens unit B1, and fW and fT respectively represent focal lengths of the entire zoom lens at the wide-angle end and at the telephoto end. When the aperture stop SP is disposed on the object side further than the third lens unit B3, TDW represents a length of the entire zoom lens an the wide-angle end, and DSP represents an air-equivalent distance (which corresponds to a distance when a parallel plate such as a filter is removed) from the aperture stop SP to the image plane IP at the wide-angle end. Moreover, m2 represents a movement amount of the second lens unit B2 during zooming from the wide-angle end to the telephoto end.

Furthermore, when the rear unit PR is constituted by the fourth lens unit B4 having a positive refractive power and the fifth lens unit B5 having a positive refractive power, the fifth lens unit B5 includes the first lens component B51 having a negative refractive power and the second lens component B52 having a positive refractive power, and a correcting lens component IS that is one of the first and second lens components B51 and B52 is moved in the shift direction having the directional component orthogonal to the optical axis to move the imaging position in the direction orthogonal to the optical axis, βa represents a lateral magnification of the correcting lens component IS at the telephoto end, and βb represents a lateral magnification of a lens component disposed on the image side further than the correcting lens component IS at the telephoto end. When no lens component is disposed on the image side than the correcting lens component IS, βb is defined to be equal to 1.

In addition, the movement amount of the lens unit during zooming from the wide-angle end to the telephoto end is a difference in positions of the lens unit in the optical axis direction at the wide-angle end and the telephoto end. A movement amount of the lens unit when a position of the lens unit at the wide-angle end is located on the image side further than that at the telephoto end is shown as a positive movement amount. Under these definitions, the zoom lens of each embodiment satisfies at least one of the following conditions.

0.8<|f1n|/f1<2.0 (3)

2.0<f1/√(fW×fT)<4.0 (4)

0.2<DSP/TDW<0.7 (5)

1.5<|m2|/√(fW×fT)<3.0 (6)

0.4<|(1−βa)×βb|<1.5 (7)

0.5<f1/fT<1.5 (8)

Description will hereinafter be made of technical meanings of each of conditions (3) to (8).

Condition (3) limits the focal length of the negative lens included in the first lens unit B1 by using the focal length of the first lens unit B1. A too long focal length of the negative lens which makes a value of |f1n|/f1 higher than the upper limit of the condition (3) makes it difficult to move the image side principal point of the first lens unit B1 to the image side and makes it difficult to correct chromatic aberration. A too short focal length of the negative lens which makes the value of |f1n|/f1 lower than the lower limit of the condition (3) makes it difficult to correct field curvature generated at the wide-angle end and makes it difficult to achieve a high zoom ratio and miniaturization of the zoom lens. Moreover, the too short focal length of the negative lens makes it difficult to correct chromatic aberration while preventing insufficient correction of lower rays of the off-axis light flux at the telephoto side.

Condition (4) limits the refractive power of the first lens unit B1 in order mainly to increase the angle of view while suppressing generation of spherical aberration and coma aberration. A lower refractive power of the first lens unit B1 which corresponds to a higher value of f1/√(fW×fT) than the upper limit of condition (4) makes it difficult to reduce the length of the entire zoom lens (length from a most-object side lens surface of the first lens unit B1 to the image plane IP) and makes it difficult to achieve a high zoom ratio. A higher refractive power of the first lens unit B1 which corresponds to a lower value of f1/√(fW×fT) than the lower limit of condition (4) causes large amounts of spherical aberration and coma aberration, which makes it difficult to correct these aberrations.

Condition (5) limits a position of the aperture stop SP at the wide-angle end. A larger value of DSP/TDW than the upper limit of condition (5) increases variation of distances from the optical axis to incident positions of the off-axis light flux on the respective lens units disposed on the image side further than the aperture stop SP, which undesirably increases numbers of lenses and aspheric surfaces necessary to correct off-axis aberration well. A smaller value of DSP/TDW than the lower limit of condition (5) makes an incident position of the off-axis light flux on the first lens unit B1 apart from the optical axis at the telephoto side, which undesirably increases the effective diameter of the first lens unit B1.

Condition (6) limits the movement amount of the second lens unit B2 during zooming in order to miniaturize the entire zoom lens while securing a necessary zoom ratio. A too large movement amount of the second lens unit B2 which makes a value of |m2|/√(fW×fT) higher than the upper limit of condition (6) undesirably makes it difficult to reduce the length of the entire zoom lens at the wide-angle end and undesirably increases the effective diameter of the first lens unit B1. A too small movement amount of the second lens unit B2 which makes the value of |m2|/√(fW×fT) lower than the lower limit of condition (6) makes it necessary to increase the refractive power of the second lens unit B5 in order to secure the necessary zoom ratio, which increases variation of field curvature with zooming and thereby makes it difficult to correct the field curvature well in the entire zoom range.

Condition (7) limits an image shift sensitivity (image stabilization sensitivity) of the correcting lens component IS of the fifth lens unit (rearmost lens unit) B5. The image shift sensitivity TS is a ratio of a movement amount ΔL of the correcting lens component IS in the shift direction (for example, in the direction orthogonal to the optical axis) to a movement amount ΔI of an optical image (imaging position) on the image plane IP in the direction orthogonal to the optical axis, that is,

TS=ΔI/ΔL.

A larger value of |(1−βa)×βb| than the upper limit of condition (7) causes the optical image to significantly shift (move) with respect to a minute movement of the correcting lens component IS, which undesirably requires a high control accuracy of the movement amount of the correcting lens component IS. A smaller value of |(1−βa)×βb| than the lower limit of condition (7) increases the movement amount of the correcting lens component IS necessary to shift the optical image by a necessary movement amount, which makes it difficult to miniaturize the entire zoom lens and makes it difficult to suppress aberration variation with the shift of the correcting lens component IS to shift the optical image by the necessary movement amount. In order to miniaturize the correcting lens component IS and reduce its weight, it is desirable that the correcting lens component IS be constituted by single lens component (that is, a single lens or a cemented lens).

Condition (8) limits the refractive power of the first lens unit B1. A lower refractive power of the first lens unit B1 which makes a value of f1/fT higher than the upper limit of condition (8) increases the length of the entire zoom lens and increases spherical aberration and coma aberration, which makes it difficult to correct such various aberrations well. A higher refractive power of the first lens unit B1 which makes the value or f1/fT lower than the lower limit of condition (8) reduces the length of the entire zoom lens, but increases a tilt of the image plane due to manufacturing error and image movement due to zooming, which undesirably makes it necessary to provide a highly accurately manufactured lens barrel.

It is more desirable to satisfy the following conditions (1a) to (8a):

5.0<f1/|f2|<6.0 (1a)

0.2<(R1+R2)/(R1−R2)≦1.0 (2a)

0.8<|f1n|/f1<1.5 (3a)

2.5<f1/√(fW×fT)<3.8 (4a)

0.2<DSP/TDW<0.5 (5a)

1.7<|m2|/√(fW×fT)<2.5 (6a)

0.4<|(1−βa)×βb|<0.8 (7a)

0.6<f1/fT<1.2 (8a)

Satisfying condition (1a) facilitates suppression of variations of coma aberration and field curvature with zooming.

Satisfying condition (2a) facilitates reduction of the effective diameter of the first lens unit B1 and good correction of spherical aberration and coma aberration on the telephoto side. Satisfying condition (3a) facilitates reduction of the effective diameter of the first lens unit B1 and good correction of the lower rays of the off-axis light flux on the telephoto side. Satisfying condition (4a) facilitates good correction of spherical aberration on the telephoto side and reduction of the length of the entire zoom lens.

Satisfying condition (5a) makes the position of the aperture stop SP more appropriate and thereby facilitates suppression of increase of the effective diameter of the first lens unit B1 while achieving a wide angle of view. Satisfying condition (6a) makes the movement amount of the second lens unit B2 more appropriate and thereby facilitates increase of the zoom ratio and miniaturization of the entire zoom lens. Satisfying condition (7a) makes the image shift sensitivity of the correcting lens component IS that shifts the optical image for image stabilization more appropriate, which facilitates the shift of the optical image while maintaining a high optical performance. Satisfying condition (8a) facilitates good correction of field curvature in the entire zoom range.

It is further desirable to set the numerical ranges of conditions (1a) to (8a) to the following numerical ranges.

5.0<f1/|f2|<5.5 (1b)

0.5<(R1+R2)/(R1−R2)≦1.0 (2b)

0.9<|f1n|/f1<1.5 (3b)

2.6<f1/√(fW×fT)<3.5 (4b)

0.3<DSP/TDW<0.4 (5b)

1.8<|m2|/√(fW×fT)<2.4 (6b)

0.5<|(1−βa)×βb|<0.7 (7b)

0.7<f1/fT<1.1 (8b)

As described above, each embodiment appropriately sets the refractive powers of the respective lens units and other parameters to provide a zoom lens having a good optical performance in the entire zoom range from the wide-angle end to the telephoto end while achieving a high zoom ratio and a wide angle of view and maintaining a small effective diameter of the front lens unit.

More specifically, each embodiment increases the refractive powers of the first and second lens units B1 and B2 to some extent so as to achieve a wide angle of view. Moreover, each embodiment decreases a distance between the first lens unit B1 and the aperture stop SP so as to maintain a small effective diameter of the first lens unit B1 and thereby achieves a small front lens effective diameter. Furthermore, each embodiment increases the refractive power of the third lens unit B3 to some extent so as to reduce a distance between the aperture stop SP and the image plane IP and thereby reduces the length of the entire zoom lens.

In addition, each embodiment moves, from the wide-angle end to the telephoto end, the second lens unit B2 to the image side, that is, increases a distance between the first and second lens units B1 and B2 to provide a magnification varying effect. Moreover, each embodiment moves the fourth lens unit B4 to perform focusing on from the infinite object to the close distance object.

Each embodiment employs such a configuration to achieve a high zoom ratio while reducing the length of the entire zoom lens from the wide-angle end to the telephoto end.

Furthermore, each of Embodiments 1 to 4 provides an aspheric lens in the third lens unit B3 so as to sufficiently correct spherical aberration and coma aberration on the wide-angle side while securing a necessary brightness. Specifically, each of Embodiments 1 to 4 forms at least one lens surface of a positive lens constituting the third lens unit B3 as an aspheric lens surface to sufficiently correct these aberrations. That is, each of Embodiments 1 to 4 generates at the aspheric lens surface aberration inverse to that generated at a reference lens surface of the positive lens to balance the aberrations generated at the reference lens surface and the aspheric lens surface.

Moreover, each of Embodiments 3 and 4 provides an aspheric lens to the second lens unit B2 to further improve the optical performance, particularly to prevent a tilt of the image plane on the wide-angle side. In addition, Embodiment 3 provides to a most-object side negative lens included in the second lens unit B2 an aspheric lens surface whose negative refractive power decreases from its center to its periphery to enable good aberration correction.

Next, description will be made of a video camera as an image pickup apparatus which is a fifth embodiment (Embodiment 5) of the present invention with reference to FIG. 12, and of a digital still camera which is another image pickup apparatus which is a sixth embodiment (Embodiment 6) of the present invention with reference to FIG. 13. These cameras are each provided with any one of the zoom lenses of Embodiments 1 to 4.

In FIG. 12, reference numeral 10 denotes a camera body, and reference numeral 11 denotes an image capturing optical system constituted by the zoom lens described in any one of Embodiments 1 to 4. Reference numeral 12 denotes a solid-state image sensor (photoelectric conversion element) such as a CCD sensor or a CMOS sensor. The image sensor 12 is provided inside the camera body 10 and receives (photoelectrically converts) an object image formed by the image capturing optical system 11. Reference numeral 13 denotes an electronic viewfinder that is constituted by a liquid crystal display panel or the like and enables observation of the object image captured by the image sensor 12.

In FIG. 13, reference numeral 20 denotes a camera body, and reference numeral 21 represents an image capturing optical system constituted by the zoom lens described in any one of Embodiments 1 to 4. Reference numeral 22 denotes a solid-state image sensor (photoelectric conversion element) such as a. CCD sensor or a CMOS sensor. The image sensor 22 is provided inside the camera body 20 and receives (photoelectrically converts) an object image formed by the image capturing optical system 21.

It is desirable that the above-described cameras include a circuit that electrically corrects at least one of distortion and chromatic aberration of magnification. Such a configuration allowing the aberration facilitates reduction of the number of lenses in the zoom lens and miniaturization of the entire zoom lens. Moreover, such electrical correction of the chromatic aberration of magnification facilitates reduction of color blur in a captured image and improvement of resolution thereof.

Next, specific numerical values of Numerical Examples 1 to 4 are shown, which respectively correspond to Embodiment 1 to 4. In each numerical example, i represents a surface number counted from the object side, ri (i=1, 2, 3, . . . ) represents a curvature radius of an i-th lens surface, and di represents an axial distance between the i-th lens surface and an (i+1)-th lens surface. Moreover, ndi and νdi respectively represent a refractive index and an Abbe number of a material of an i-th lens for the d-line. Two most-image side surfaces correspond to the glass block G.

When the lens surface has an aspheric shape, which is shown by “*”, the aspheric shape is expressed by the following expression where X represents a position (coordinate) in the optical axis direction, H represents a position (coordinate) in a direction orthogonal to the optical axis, a direction in which light proceeds is defined as a positive direction, R represents a paraxial curvature radius, K represents a conic constant, and A4, A6, A8 and A10 represent aspheric coefficients:

$$X = \frac{\frac{{H}^{2}}{R}}{1 + \sqrt{1 - ( 1 + K ) {( \frac{H}{R} )}^{2}}} + A 4 {H}^{4} + A 6 {H}^{6} + A 8 {H}^{8} + A 10 {H}^{10}$$

In addition, “e±x” represents “×10^{±x}”. Furthermore, BF represents a back focus as an air-equivalent value.

Table 1 shows values in Numerical Examples 1 to 4 corresponding to the parameters in the above-described conditions and values of the above-described conditions in Numerical Examples 1 to 4. Each numerical example shows an F-number, an angle of view (°), an image height, a length of the entire zoom lens, the back focus BF and others at each of four focal lengths corresponding to the wide-angle end, the first intermediate zoom position, the second intermediate zoom position and the telephoto end. A half angle of view is shown as a value calculated by ray tracing.

### NUMERICAL EXAMPLE 1

Unit mm
Surface Data

| Surface No. | r | d | nd | νd |
|---|---|---|---|---|
| 1 | −344.066 | 1.50 | 1.84666 | 23.8 |
| 2 | 50.245 | 4.07 | 1.60311 | 60.6 |
| 3 | −164.337 | 0.20 | | |
| 4 | 49.901 | 2.95 | 1.80400 | 46.6 |
| 5 | −700.592 | 0.17 | | |
| 6 | 26.799 | 2.05 | 1.77250 | 49.6 |
| 7 | 48.404 | (Variable) | | |
| 8 | 115.929 | 0.70 | 1.88300 | 40.8 |
| 9 | 8.374 | 2.63 | | |
| 10 | −13.413 | 0.60 | 1.80000 | 29.8 |
| 11 | 14.604 | 1.50 | | |
| 12 | −15.366 | 0.60 | 1.88300 | 40.8 |
| 13 | −34.927 | 0.20 | | |
| 14 | 40.719 | 2.03 | 1.92286 | 18.9 |
| 15 | −18.683 | (Variable) | | |
| 16(SP) | ∞ | 1.20 | | |
| 17* | 16.419 | 3.45 | 1.55332 | 71.7 |
| 18* | −21.931 | (Variable) | | |
| 19 | 12.803 | 0.60 | 1.84666 | 23.8 |
| 20 | 6.466 | 2.13 | 1.63854 | 55.4 |
| 21 | −64.684 | (Variable) | | |
| 22* | 35.578 | 1.02 | 1.83481 | 42.7 |
| 23 | −46.779 | 0.50 | 1.64769 | 33.8 |
| 24 | 5.419 | 3.47 | | |
| 25 | 10.055 | 3.23 | 1.51633 | 64.1 |
| 26 | −9.717 | 3.00 | | |
| 27 | ∞ | 1.00 | 1.51633 | 64.1 |
| 28 | ∞ | 1.00 | | |
| IP | ∞ | | | |

Aspheric Surface Data
17th surface

| | | |
|---|---|---|
| K = −6.51338e−001 | A4 = −8.42369e−005 | A6 = −2.73669e−008 |
| A8 = −1.56859e−008 | A10 = 3.10785e−010 | |

18th surface

| | | |
|---|---|---|
| K = −4.76736e+000 | A4 = −4.65862e−005 | A6 = −1.49561e−007 |

22nd surface

| | |
|---|---|
| K = 3.24617e+001 | A4 = −2.09482e−004 |

Various Data
Zoom Ratio 13.57

| | | INTER- | INTER- | |
|---|---|---|---|---|
| | WIDE | MEDIATE 1 | MEDIATE 2 | TELE |
| Focal Length | 3.64 | 11.01 | 22.91 | 49.32 |
| F-number | 1.80 | 2.38 | 2.62 | 2.80 |
| Half Angle of View(°) | 36.60 | 11.55 | 5.61 | 2.61 |
| Image height | 2.70 | 2.25 | 2.25 | 2.25 |
| Entire Lens Length | 75.25 | 75.25 | 75.25 | 75.25 |
| BF | 4.66 | 4.66 | 4.66 | 4.66 |
| d7 | 0.70 | 14.78 | 20.61 | 24.98 |
| d15 | 25.88 | 11.80 | 5.97 | 1.60 |
| d18 | 8.17 | 5.31 | 4.38 | 6.78 |
| d21 | 1.04 | 3.90 | 4.83 | 2.43 |

Lens Unit Data

| Unit | Starting Surface | Focal Length |
|---|---|---|
| 1 | 1 | 36.16 |
| 2 | 8 | −6.70 |
| 3 | 16 | 17.53 |
| 4 | 19 | 22.81 |
| 5 | 22 | 20.93 |

### NUMERICAL EXAMPLE 2

Unit mm
Surface Data

| Surface No. | r | d | nd | νd |
|---|---|---|---|---|
| 1 | −135.961 | 1.50 | 1.90366 | 31.3 |
| 2 | 44.629 | 0.95 | | |
| 3 | 64.758 | 3.78 | 1.60311 | 60.6 |
| 4 | −118.605 | 0.15 | | |
| 5 | 41.339 | 4.25 | 1.71300 | 53.9 |
| 6 | −157.378 | 0.15 | | |
| 7 | 32.789 | 2.40 | 1.69680 | 55.5 |
| 8 | 80.447 | (Variable) | | |
| 9 | 269.050 | 0.70 | 1.88300 | 40.8 |
| 10 | 9.053 | 1.92 | | |
| 11 | −279.080 | 0.60 | 1.92286 | 20.9 |
| 12 | 11.014 | 2.37 | | |
| 13 | −11.741 | 0.60 | 1.74400 | 44.8 |
| 14 | −33.583 | 0.10 | | |
| 15 | 38.458 | 2.00 | 1.95906 | 17.5 |
| 16 | −20.816 | (Variable) | | |
| 17(SP) | ∞ | 1.20 | | |
| 18* | 15.482 | 2.51 | 1.59201 | 67.0 |
| 19* | 160.382 | (Variable) | | |
| 20* | 11.494 | 2.04 | 1.68893 | 31.1 |
| 21 | −276.118 | 0.15 | | |
| 22 | 21.492 | 0.60 | 1.92286 | 20.9 |
| 23 | 6.364 | 3.14 | 1.51633 | 64.1 |
| 24 | −56.611 | (Variable) | | |
| 25 | ∞ | 1.00 | 1.51633 | 64.1 |
| 26 | ∞ | 1.00 | | |
| IP | ∞ | | | |

Aspheric Surface Data
18th surface

| | | |
|---|---|---|
| K = 1.27083e+000 | A4 = −1.62706e−004 | A6 = −8.28378e−007 |
| A8 = −1.15364e−008 | A10 = 1.85815e−010 | |

19th surface

| | | |
|---|---|---|
| K = 0.00000e+000 | A4 = −8.01028e−005 | A6 = −2.57494e−007 |

20th surface

| | | |
|---|---|---|
| K = −7.18029e−001 | A4 = −9.01823e−006 | A6 = 5.20604e−007 |

Various Data
Zoom Ratio 11.85

| | | INTER- | INTER- | |
|---|---|---|---|---|
| | WIDE | MEDIATE 1 | MEDIATE 2 | TELE |
| Focal Length | 3.48 | 11.04 | 24.37 | 41.30 |
| F-number | 1.80 | 2.45 | 2.73 | 2.88 |
| Half Angle of View(°) | 36.73 | 11.52 | 5.28 | 3.12 |
| Image height | 2.60 | 2.25 | 2.25 | 2.25 |
| Entire Lens Length | 81.12 | 81.12 | 81.12 | 81.12 |
| BF | 10.54 | 13.35 | 14.51 | 13.32 |
| d8 | 0.70 | 17.39 | 24.63 | 28.52 |
| d16 | 29.42 | 12.73 | 5.49 | 1.60 |
| d19 | 9.35 | 6.54 | 5.38 | 6.57 |
| d24 | 8.88 | 11.69 | 12.85 | 11.66 |

Lens Unit Data

| Unit | Starting Surface | Focal Length |
|---|---|---|
| 1 | 1 | 39.90 |
| 2 | 9 | −7.86 |
| 3 | 17 | 28.76 |
| 4 | 20 | 19.12 |

### NUMERICAL EXAMPLE 3

Unit mm
Surface Data

| Surface No. | r | d | nd | νd |
|---|---|---|---|---|
| 1 | ∞ | 1.50 | 1.84666 | 23.8 |
| 2 | 41.344 | 1.80 | | |
| 3 | 94.752 | 3.03 | 1.48749 | 70.2 |
| 4 | −126.575 | 0.15 | | |
| 5 | 46.422 | 2.80 | 1.69680 | 55.5 |
| 6 | 297.361 | 0.15 | | |
| 7 | 37.804 | 3.27 | 1.83481 | 42.7 |
| 8 | 1147.293 | (Variable) | | |
| 9 | −124.873 | 0.60 | 1.85135 | 40.1 |
| 10* | 7.294 | 2.81 | | |
| 11 | −16.328 | 0.60 | 1.80400 | 46.6 |
| 12 | 47.325 | 0.20 | | |
| 13 | 19.795 | 1.81 | 1.92286 | 18.9 |
| 14 | −76.231 | (Variable) | | |
| 15(SP) | ∞ | 1.20 | | |
| 16* | 20.125 | 3.33 | 1.55332 | 71.7 |
| 17* | −24.740 | (Variable) | | |
| 18 | 23.545 | 0.60 | 1.84666 | 23.8 |
| 19 | 9.952 | 2.14 | 1.63854 | 55.4 |
| 20 | −25.683 | (Variable) | | |
| 21* | 45.164 | 1.16 | 1.88300 | 40.8 |
| 22 | −52.263 | 0.60 | 1.67270 | 32.1 |
| 23 | 6.244 | 1.82 | | |
| 24 | 7.565 | 3.50 | 1.69680 | 55.5 |
| 25 | −428.888 | 3.30 | | |
| 26 | ∞ | 1.00 | 1.51633 | 64.1 |
| 27 | ∞ | 1.00 | | |
| IP | ∞ | | | |

Aspheric Surface Data
10th surface

| | |
|---|---|
| K = −1.10126e−001 | A4 = −1.61117e−005 |

16th surface

| | | |
|---|---|---|
| K = −2.63299e+000 | A4 = 2.93548e−006 | A6 = −3.06369e−009 |
| A8 = 1.93110e−008 | A10 = −2.66803e−010 | |

17th surface

| | | |
|---|---|---|
| K = −5.96116e+000 | A4 = 1.08153e−005 | A6 = 6.08640e−007 |

21st surface

| | |
|---|---|
| K = −7.26973e+001 | A4 = 1.08789e−004 |

Various Data
Zoom Ratio 11.99

| | | INTER- | INTER- | |
|---|---|---|---|---|
| | WIDE | MEDIATE 1 | MEDIATE 2 | TELE |
| Focal Length | 3.81 | 15.73 | 27.56 | 45.70 |
| F-number | 1.80 | 2.48 | 2.69 | 2.88 |
| Half Angle of View(°) | 34.31 | 10.80 | 6.21 | 3.76 |
| Image height | 2.60 | 3.00 | 3.00 | 3.00 |
| Entire Lens Length | 79.68 | 79.68 | 79.68 | 79.68 |
| BF | 4.96 | 4.96 | 4.96 | 4.96 |
| d8 | 0.70 | 18.05 | 23.28 | 28.24 |
| d14 | 29.14 | 8.95 | 4.35 | 1.60 |
| d17 | 8.69 | 5.93 | 3.95 | 4.69 |
| d20 | 3.14 | 8.74 | 10.09 | 7.14 |

Lens Unit Data

| Unit | Starting Surface | Focal Length |
|---|---|---|
| 1 | 1 | 39.66 |
| 2 | 9 | −7.87 |
| 3 | 15 | 20.60 |
| 4 | 18 | 25.40 |
| 5 | 21 | 42.15 |

### NUMERICAL EXAMPLE 4

Unit mm
Surface Data

| Surface No. | r | d | nd | νd |
|---|---|---|---|---|
| 1 | −800.000 | 1.50 | 1.90366 | 31.3 |
| 2 | 39.916 | 0.82 | | |
| 3 | 45.540 | 4.51 | 1.60311 | 60.6 |
| 4 | −166.248 | 0.15 | | |
| 5 | 37.763 | 3.89 | 1.69680 | 55.5 |
| 6 | −808.672 | 0.15 | | |
| 7 | 36.152 | 1.96 | 1.69680 | 55.5 |
| 8 | 72.304 | (Variable) | | |
| 9 | −130.913 | 0.70 | 2.00100 | 29.1 |
| 10 | 8.032 | 3.36 | | |
| 11 | −16.195 | 0.60 | 1.91082 | 35.3 |
| 12 | 18.017 | 2.42 | 2.00178 | 19.3 |
| 13* | −23.343 | (Variable) | | |
| 14(SP) | ∞ | 1.20 | | |
| 15* | 14.319 | 2.18 | 1.59201 | 67.0 |
| 16* | −88.129 | (Variable) | | |
| 17 | 11.007 | 0.50 | 1.84666 | 23.8 |
| 18 | 6.235 | 2.45 | 1.63854 | 55.4 |
| 19 | −42.556 | (Variable) | | |
| 20 | 11.433 | 0.70 | 1.55332 | 71.7 |
| 21* | 4.539 | 2.13 | | |
| 22 | 8.024 | 2.16 | 1.56384 | 60.7 |
| 23 | −22.110 | 0.50 | 1.95906 | 17.5 |
| 24 | −850.000 | 4.40 | | |
| 25 | ∞ | 1.00 | 1.51633 | 64.1 |
| 26 | ∞ | 1.00 | | |
| IP | ∞ | | | |

Aspheric Surface Data
13th surface

| | | |
|---|---|---|
| K = 8.00261e−001 | A4 = −5.85355e−005 | A6 = −5.61599e−007 |

15th surface

| | | |
|---|---|---|
| K = 5.69141e−001 | A4 = 1.42937e−005 | A6 = 1.76326e−006 |
| A8 = 1.42819e−007 | A10 = −1.67455e−009 | |

16th surface

| | | |
|---|---|---|
| K = −8.78133e+002 | A4 = 3.70614e−005 | A6 = 8.23852e−006 |

21st surface

| | |
|---|---|
| K = −3.87586e−001 | A4 = 1.40888e−004 |

Various Data
Zoom Ratio 11.83

| | | INTER- | INTER- | |
|---|---|---|---|---|
| | WIDE | MEDIATE 1 | MEDIATE 2 | TELE |
| Focal Length | 3.47 | 11.03 | 28.06 | 41.04 |
| F-number | 1.80 | 2.45 | 2.77 | 2.88 |
| Half Angle of View(°) | 36.85 | 11.53 | 4.58 | 3.14 |
| Image height | 2.60 | 2.25 | 2.25 | 2.25 |
| Entire Lens Length | 75.82 | 75.82 | 75.82 | 75.82 |
| BF | 6.06 | 6.06 | 6.06 | 6.06 |
| d8 | 0.70 | 17.43 | 25.79 | 28.58 |
| d13 | 29.58 | 12.85 | 4.49 | 1.70 |
| d16 | 6.34 | 4.09 | 2.96 | 3.51 |
| d19 | 1.26 | 3.50 | 4.63 | 4.09 |

Lens Unit Data

| Unit | Starting Surface | Focal Length |
|---|---|---|
| 1 | 1 | 41.70 |
| 2 | 9 | −7.65 |
| 3 | 14 | 20.97 |
| 4 | 17 | 17.26 |
| 5 | 20 | 117.66 |

TABLE 1

| | Embodi- | Embodi- | Embodi- | Embodi- |
|---|---|---|---|---|
| CONDITION | ment 1 | ment 2 | ment 3 | ment 4 |
| fW | 3.636 | 3.484 | 3.810 | 3.469 |
| fT | 49.318 | 41.295 | 45.697 | 41.039 |
| f1 | 36.158 | 39.896 | 39.658 | 41.702 |
| f2 | −6.702 | −7.865 | −7.868 | −7.654 |
| f3 | 17.531 | 28.759 | 20.601 | 20.973 |
| f4 | 22.808 | 19.123 | 25.402 | 17.261 |
| f5 | 20.927 | — | 42.152 | 117.662 |
| f1n | −51.681 | −37.036 | −48.832 | −42.036 |
| TDW | 75.247 | 81.117 | 79.675 | 75.819 |
| DSP | 29.465 | 29.529 | 31.133 | 25.479 |
| m2 | 24.278 | 27.820 | 27.535 | 27.877 |
| (1) f1/\|f2\| | 5.395 | 5.073 | 5.040 | 5.449 |
| (2) (R1 + R2)/(R1 − R2) | 0.745 | 0.506 | 1.000 | 0.905 |
| (3) \|f1n\|/f1 | 1.429 | 0.928 | 1.231 | 1.008 |
| (4) f1/√(fW × fT) | 2.700 | 3.326 | 3.005 | 3.495 |
| (5) DSP/TDW | 0.392 | 0.364 | 0.391 | 0.336 |
| (6) \|m2\|/√(fW × fT) | 1.813 | 2.319 | 2.087 | 2.336 |
| (7) \|(1 − βa) × βb\| | 0.685 | — | 0.619 | 0.628 |
| (8) f1/fT | 0.733 | 0.966 | 0.868 | 1.016 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-238822, filed Oct. 30, 2012, which is hereby incorporated by reference herein in its entirety.

What is claimed is:

1. A zoom lens comprising in order from an object side to an image side:
a first lens unit having a positive refractive power;
a second lens unit having a negative refractive power;
a third lens unit having a positive refractive power; and
a rear lens group including at least one lens unit,
wherein:
the second lens unit and a most-object side lens unit of the rear lens group are moved during zooming, and the first lens unit is not moved for zooming;
the first lens unit includes, in order from the object side to the image side, one negative lens and three positive lenses; and
the following conditions are satisfied:
5.0<f1/|f2|<7.0
−0.2<(R1+R2)/(R1−R2)<1.1
where f1 represents a focal length of the first lens unit, f2 represents a focal length of the second lens unit, and R1 and R2 respectively represent curvature radii of an object side lens surface and an image side lens surface of the negative lens included in the first lens unit.

2. A zoom lens according to claim 1, wherein the following condition is satisfied:
0.8<|f1n|/f1<2.0
where f1n represents a focal length of the negative lens included in the first lens unit.

3. A zoom lens according to claim 1, wherein the following condition is satisfied:
2.0<f1/√(fW×fT)<4.0
where fW and fT respectively represent focal lengths of the entire zoom lens at a wide-angle end and at a telephoto end.

4. A zoom lens according to claim 1, further comprising an aperture stop disposed on the object side further than the third lens unit,
wherein the following condition is satisfied:
0.2<DSP/TDW<0.7
where TDW represents a length of the entire zoom lens at a wide-angle end, and DSP represents an air-equivalent distance from the aperture stop to an image plane of the zoom lens at the wide-angle end.

5. A zoom lens according to claim 1, wherein the following condition is satisfied:
1.5<|m2|/√(fW×fT)<3.0
where m2 represents a movement amount of the second lens unit during zooming from a wide-angle end to a telephoto end, and fW and fT respectively represent focal lengths of the entire zoom lens at the wide-angle end and at the telephoto end.

6. A zoom lens according to claim 1, wherein the following condition is satisfied:
0.5<f1/fT<1.5
where fT represent a focal length of the entire zoom lens at a telephoto end.

7. A zoom lens according to claim 1, wherein:
the rear lens group includes, in order from the object side to the image side, a fourth lens unit having a positive refractive power, and a fifth lens unit having a positive refractive power, the fifth lens unit including a first lens component having a negative refractive power and a second lens component having a positive refractive power;
a correcting lens component that is one of the first and second lens components is moved in a direction having a directional component orthogonal to an optical axis of the zoom lens for correction of image blur due to shaking of the zoom lens; and
the following condition is satisfied:
0.4<|(1−βa)×βb|<1.5
where βa represents a lateral magnification of the correcting lens component at a telephoto end, and βb represents a lateral magnification of a lens component disposed on the image side than the correcting lens component at the telephoto end, βb being defined to be equal to 1 when no lens component disposed on the image side further than the correcting lens component.

8. A zoom lens according to claim 1, wherein the rear lens group includes, in order from the object side to the image side, a fourth lens unit having a positive refractive power, and a fifth lens unit having a positive refractive power, the fifth lens unit being not moved during zooming.

9. A zoom lens according to claim 1, wherein the rear lens group consists of a fourth lens unit having a positive refractive power.

10. An image pickup apparatus comprising:
a zoom lens; and
an image sensor to photoelectrically converts an optical image formed by the zoom lens,
wherein the zoom lens comprises in order from an object side to an image side:
first lens unit having a positive refractive power;
a second lens unit having a negative refractive power;
a third lens unit having a positive refractive power; and
a rear lens group including at least one lens unit,
wherein:
the second lens unit and a most-object side lens unit of the rear lens group are moved during zooming, and the first lens unit is not moved for zooming;
the first lens unit includes, in order from the object side to the image side, one negative lens and three positive lenses; and
the following conditions are satisfied:
5.0<f1/|f2|<7.0
−0.2<(R1+R2)/(R1−R2)<1.1
where f1 represents a focal length of the first lens unit, f2 represents a focal length of the second lens unit, and R1 and R2 respectively represent curvature radii of an object side lens surface and an image side lens surface of the negative lens included in the first lens unit.
